(19) United States
(12) Patent Application Publication
(10) Pub. No.: US 2023/0022372 A1
(43) Pub. Date: Jan. 26, 2023

(54) COMBINED HEAT AND POWER SYSTEMS INCLUDING POWER CELLS, AND ASSOCIATED METHODS

(71) Applicant: Modern Electron, Inc., Bothell, WA (US)

(72) Inventors: Vikas Patnaik, Mukilteo, WA (US); Ethan N. DiNinno, Bothell, WA (US); Patrick D. Noble, Seattle, WA (US)

(21) Appl. No.: 17/870,604

(22) Filed: Jul. 21, 2022

Related U.S. Application Data
(60) Provisional application No. 63/224,066, filed on Jul. 21, 2021.

(51) Int. Cl. H02J 3/38; H02J 3/00

(52) U.S. Cl. CPC H02J 3/388; H02J 3/002

(57) ABSTRACT

Combined heat and power systems and associated methods are disclosed herein. In some embodiments, the combined heat and power (CHP) system includes a heating appliance, a power cell thermally coupled to the heating appliance and configured to receive a portion of the heat generated by the heating appliance, and power electronics operatively coupled to the heating appliance and the power cell. The power cell can generate a power output from the heat generated by the heating appliance. The power electronics can include a controller configured to detect a loss in external power, and in response enter a blackout operation mode in which the heating appliance is electrically coupled to an energy storage device and/or electrically isolated from an external grid.

### CROSS-REFERENCE TO RELATED APPLICATION(S)

This application claims priority to U.S. Provisional Application No. 63/224,066, filed Jul. 21, 2021, the disclosure of which is incorporated herein by reference in its entirety.

### TECHNICAL FIELD

The present technology is generally related to combined heat and power systems including power cells, and associated methods. In particular embodiments, the present technology relates to controlling power distribution in a combined heat and power system between an external power source and various internal power sources.

### BACKGROUND

Combined heat and power (“CHP”) systems, sometimes also referred to as co-generation systems, can generate both heat and electrical power in the same device and/or location. Typically, a fuel is combusted to generate heat that is then transferred into a local electrical power generator and/or into another device, such as a heating appliance (e.g., a furnace, water boiler and/or water heater, and the like), a cooling application (e.g., an absorption chiller), and the like. Further, any unused heat (e.g., excess or waste heat) from the local electrical power generator can be delivered to the heating appliance. Accordingly, the CHP system can generate usable electricity while also supplying the heat necessary to operate the heating and/or cooling appliances. As a result, CHP systems can improve the overall efficiency of current heating and/or cooling appliances. Based on this improvement in overall efficiency, CHP systems can offer decreased carbon emissions and produce energy cost savings.

### BRIEF DESCRIPTION OF THE DRAWINGS

FIG. 1 is a block diagram of a combined heat and power system in accordance with embodiments of the present technology.

FIG. 2 is a partially schematic isometric view of a combined heat and power system in accordance with embodiments of the present technology.

FIGS. 3A-3C are schematic block diagrams of a combined heat and power system illustrating various power distribution schemes, in accordance with embodiments of the present technology.

FIGS. 4A and 4B are flow diagrams of processes for operating a combined heat and power system in accordance with embodiments of the present technology.

FIG. 5 is a flow diagram of a process for warming up a combined heat and power system during a blackout in accordance with embodiments of the present technology.

FIG. 6 is a flow diagram of a process for adjusting operation of a combined heat and power system to maintain optimal power generation in accordance with embodiments of the present technology.

FIG. 7 is a schematic block diagram of a combined heat and power system illustrating a power distribution scheme, in accordance with embodiments of the present technology.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described.

### DETAILED DESCRIPTION

### Overview

Power outages (e.g., blackouts, brownouts, and the like) render heating appliances inoperable despite other supply sources being unaffected. For example, natural gas lines that feed furnaces, water boilers, water heaters, and the like are not typically affected by power outages. Nevertheless, the furnaces, water boilers, water heaters, and the like are rendered inoperable due to a lack of power available for the pumps, blowers, meters, control circuits, and the like that are necessary for the appliances to operate. The embodiments disclosed herein describe methods, apparatuses, and systems for providing a combined heat and power (CHP) system with protection against loss of power. As one example, the systems and methods that are described herein can allow a CHP system to be implemented into a furnace to allow the furnace to operate during a partial or full power outage. This protection can provide access to heat, potentially saving lives during extended blackouts and/or severe weather.

Conventional CHP systems lack the necessary controls to detect power outages, as well as the ability to adjust power distribution in the system to address the power outage and allow the CHP system to start from cold during the power outage. For example, conventional CHP systems can lack the controls necessary to redirect power in the CHP system according to various operating modes, especially operating modes beginning with an inoperable power cell.

Embodiments of the present technology can mitigate these technical deficiencies in conventional systems. In some embodiments, CHP systems of the present technology can include a heating appliance, one or more power cells thermally coupled to the heating appliance and configured to receive a portion of the heat generated therein, and power electronics operatively coupled to the heating appliance and the power cell. Among other features, the power electronics can include a controller configured to detect a reduction in the electrical power (e.g., voltage, current, etc.) available from the external grid below a predetermined threshold (e.g., a predetermined power threshold, a predetermined voltage threshold, a predetermined current threshold, etc.). The reduction in electrical power can be based on a partial power outage (e.g., a brownout) and/or a full power outage (e.g., a blackout), referred to herein collectively as a “blackout” and/or a “blackout condition.” After detecting the reduction in electrical power, the controller can determine whether the power cell is ready to operate. The determination can be based on a temperature of a hot side heat exchanger of the power cell, the temperature of a cold side heat exchanger of the power cell, and/or a temperature gradient therebetween. As an example, the power cell can require the hot side heat exchanger to be between about 800-1400° Celsius (° C.) to operate, while the cold side heat exchanger is between about 200-800° C. to operate. Additionally or alternatively, the power cell can require a temperature gradient of at least 500° C., 550° C., 600° C., 650° C., or 700° C. When the power cell is ready to operate, the controller can cause the CHP system to enter or transition to a blackout operation mode. Alternatively, when the power cell is not ready to operate, the controller can cause the CHP system to enter or transition to a warm-up blackout operation mode.

To enter and/or in the blackout operation mode, the controller can be configured to adjust a fuel consumption rate and/or combustion ratio (fuel:oxidant) of the heating appliance. This can(i) increase the heat output from the combustion, (ii) action (e.g., toggle) the power cell into an active power generation mode to produce an electrical output, and (iii) electrically couple the power cell to one or more active components of the heating appliance. As used herein, “heating appliance” can be referred to herein as appliance load(s), and can include a burner, an inducer configured to supply air (or another suitable oxidant) to the burner, an air mover (or other fluid pump) to carry heat away from the heating appliance (e.g., for home heating purposes), a controller implementing a schedule for the heating appliance and/or responding to set point changes from a thermostat, and/or the like). The increased temperature can allow the power cell to produce the electrical output while producing a sufficient heat output from the heating appliance (e.g., enough heat to warm a residential unit). In turn, the power cell can provide at least a portion of the electrical input for the active component(s) of the heating appliance.

In some embodiments, the power cell includes a thermionic converter. In such embodiments, actioning the power cell into the active power generation mode can include providing an alkali metal vapor (e.g., a Cesium vapor) to the vacuum gap of the thermionic converter and loading an electrical output contact. In other embodiments, the power cell can include a thermoelectric energy converter, an alkali metal thermal-to-electricity converter, a thermoacoustic converter, and the like.

In some embodiments, the power electronics also include a direct current (DC) to DC step-up converter and/or an inverter coupled between the power cell and the active components of the heating appliance. The DC-DC step-up converter can ensure that the electrical output from the power cell is at (or above) a required input voltage for the active components. The inverter can convert the DC electrical output to an AC output suitable for the active components.

The CHP system can also include an energy storage device (e.g., a battery) and/or be operably couplable to an external energy storage device. The energy storage device can supplement the electrical output from the power cell when the power cell is not ready to operate and/or when the power cell does not produce a sufficient electrical output to operate the heating appliance. For example, to enter the warm-up blackout operation mode, the controller is further configured to electrically couple the energy storage device to the active components of the heating appliance to provide the necessary electrical input while the power cell prepares for operation (e.g., while a hot side heat exchanger warms up). Additionally, to enter the warm-up blackout operation mode, the controller can adjust the fuel consumption rate and/or the combustion ratio of the heating appliance to increase the amount of heat output from the combustion. The increased heat can help quickly warm up the power cell to reduce reliance on the energy storage component to operate the heating appliance.

In some embodiments, the power electronics include a grid-tie inverter. In such embodiments, when there is no reduction in the external electrical power (e.g., during normal operating conditions), the controller can load the power cell and direct the electrical output into an external grid through the grid-tie inverter. For example, the electrical output from the power cell can be used to offset the energy consumption of a residential unit while the CHP system is operating (e.g., while a residential furnace is operating). Additionally or alternatively, when there is no reduction in the external electrical power, the controller can determine/monitor the charge status of the energy storage device and recharge the energy storage device. In some embodiments, the energy storage device is coupled to the external grid to recharge. In some embodiments, the energy storage device is coupled to the power cell.

Further, in some embodiments, the power cell generates excess energy during the blackout operation mode (e.g., more energy than required to operate the active components of the heating appliance). In such embodiments, the controller can use the excess energy to recharge the energy storage device. The active recharging can extend the time the CHP system can operate self-sufficiently (e.g., without energy from the external power grid). For example, when power is lost, the energy storage device can provide the power for the power cell in the CHP system to warm up. The power cell can then generate the electrical power necessary to sustain the operation while the heating appliance is operating (e.g., during a furnace cycle to heat a home) and at least partially recharge the energy storage device. After the active cycle, the power cell can cool. The energy storage device can then provide the power necessary to re-warm up the power cell. Additionally or alternatively, the power cell can direct excess power to the energy storage device when energy demands are low, and power the heating appliance in parallel with the energy storage device when energy demands are high.

In some embodiments, the controller implements processes to maintain the efficient operation of the power cell. For example, the controller can monitor the temperature of the hot and cold heat exchangers to detect when either of the heat exchangers departs from a preferred operating range (e.g., an operating range efficient enough to power the heating appliance). When a departure or near departure is detected, the controller can then adjust the operation of the power cell and/or heating appliance to return toward the preferred operating range. Purely by way of example, the controller can adjust the consumption rate and/or combustion ratio of the heating appliance to adjust the heat produced therein, as well as the available heat for the hot side heat exchanger. In another example, the controller can adjust the operating speed of a pump (e.g., an air blower, fluid pump, and the like) in the heating appliance to adjust a turnover rate of fluid contacting the cold side heat exchanger (and therefore the heat carried away from the cold side heat exchanger). In another example, the controller can adjust the load applied to the power cell to adjust the efficiency of the power produced therein.

### Description of the Figures

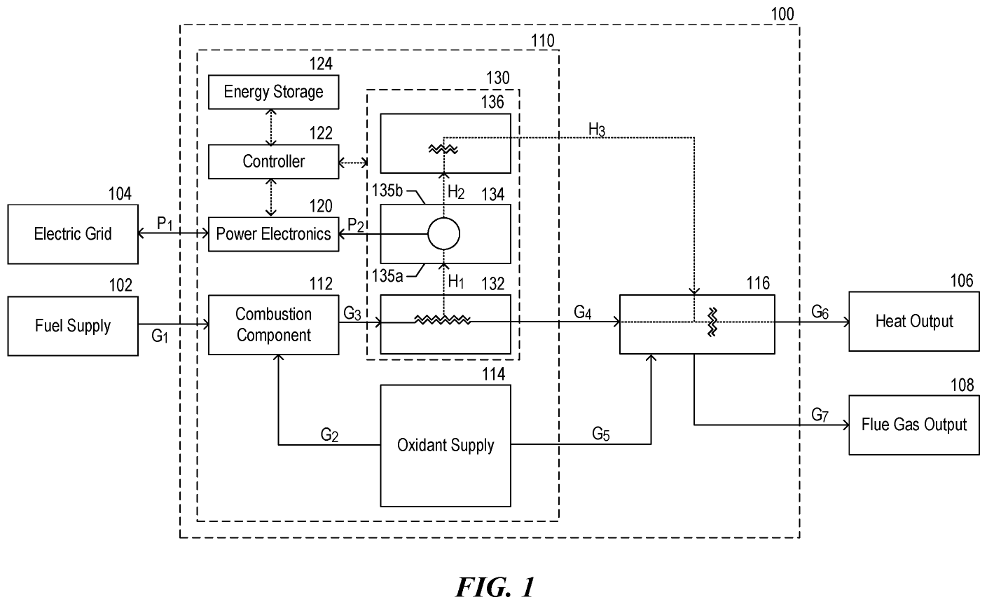

FIG. 1 is a block diagram of a CHP system 100 in accordance with some embodiments of the present technology. In the illustrated embodiment, the CHP system 100 (sometimes also referred to herein as a “co-generation system”) includes a power generation system 110 that is integrated with a heating device and/or a cooling device (referred to collectively herein as a “heating device”). The power generation system 110 includes a combustion component 112, a power cell 130 (sometimes also referred to herein as a “heat cell,” and/or a “power generation module”) thermally coupled to the combustion component 112, and an oxidant supply 114 fluidly coupled to the combustion component 112. The power generation system 110 also includes power electronics 120 and a controller 122 that are operably coupled to each of the components of the CHP system 100, as well as an energy storage device 124 that is operably coupled to the controller 122 and/or the power electronics 120. As discussed in more detail below, the power electronics 120 can provide a bridge between an external electric grid 104, the power cell 130, and/or the energy storage device 124 and various active components (e.g., appliance loads) of the CHP system 100 (e.g., the combustion component 112, the oxidant supply 114 (sometimes referred to as an inducer), air blowers in the heating appliance, fluid pumps in the heating appliance, control boards in the heating appliance, thermostat, and the like). Additionally, as also discussed in more detail below, the controller 122 can control the active components of the CHP system 100 and/or the power electronics 120 to control the flow of electricity and heat throughout the CHP system 100.

As illustrated in FIG. 1, the combustion component 112 (e.g., one or more burners, burner system, reactor, ignitor, pumps, valves, fuel mixers, and the like) is fluidly couplable to a fuel supply 102 (e.g., a natural gas input, a hydrogen gas input, and/or the like) via a first gas flow path G₁ (shown by a solid line) and the oxidant supply 114 (e.g., an air blower, an air pump input, oxygen tank input, and/or the like) via a second gas flow path G₂. In various embodiments, the fuel can be any of a variety of suitable hydrocarbon gases or fluids, such as natural gas, methane gas, fuel oil, coal, liquefied petroleum gas, and/or the like, and/or hydrogen gas. The oxidant can be any suitable oxygen-carrying agent such as air, compressed air, oxygen gas, and/or any other suitable oxygen-carrying compound. The combustion component 112, or a separate mixer (not shown), receives and mixes the fuel and the oxidant at a desired ratio (e.g., by varying the speed of an air blower or inducer coupled to a burner in the combustion component). The desired ratio can help control the temperature of the combustion of the fuel and oxidant within the combustion component 112, which can, in turn, help control the temperature of the heat output from the combustion component.

In some embodiments, the mixture includes a stoichiometric ratio (e.g., a theoretical ideal ratio for complete, efficient combustion) of the fuel with the oxygen carried by the oxidant. Purely by way of example, the stoichiometric ratio, by mass, of air to natural gas is about 17.2 to 1 (e.g., requiring about 17.2 kg of air to completely and efficiently burn 1 kg of natural gas). During normal operation of the CHP system 100 (e.g., when the electric grid 104 is available), the mixture has between about 30 percent and about 50 percent more oxygen than required for the stoichiometric ratio. The excess oxygen can ensure that the fuel is fully combusted, and control the temperature of the output communicated to a heat output 106 (e.g., hot water pipes, air duct system, and the like). During a blackout operation, as discussed in more detail below, the mixture can be closer to the stoichiometric ratio to increase the concentration of fuel in the mixture. The increased concentration can result in a higher temperature combustion and more heat being output in a unit of time. In some such embodiments, the mixture has between about 30 percent and about 50 percent more oxygen than required for the stoichiometric ratio. In still further embodiments, the mixture is within about 10 percent of the stoichiometric ratio, within about 5 percent of the stoichiometric ratio, within about 1 percent of the stoichiometric ratio, or within about 0.1 percent of the stoichiometric ratio.

The combustion component 112 combusts the mixture, resulting in a flue gas that is directed toward the power cell 130 via a third flow path G₃. Heat from the flue gas can be transferred to the power cell 130 via a first heat exchanger 132 by conduction (e.g., based on contact between the flue gas and the first heat exchanger 132) and/or radiation (e.g., through heat radiation from an intermediate substrate adjacent the first heat exchanger 132). The flue gas then flows away from the power cell 130 along a fourth flow path G₄ and toward a third heat exchanger 116 that is integrated into the heating appliance. Remaining heat in the flue gas can then be transferred to the third heat exchanger 116.

The heat transferred to the third heat exchanger 116 can be used by the heating appliance and directed to the heat output 106 (e.g., hot water pipes, air duct system, and/or the like). Purely by way of example, the oxidant supply 114 can include the air blower for a commercial furnace. In addition to supplying the oxidant along the second gas flow path G₂, the oxidant supply 114 can supply air to a flow chamber (e.g., heating chamber) of the commercial furnace along a fifth gas flow path G₅. In this example, the third heat exchanger 116 can be the shared conductive walls between a flue gas chamber and the flow chamber. In such embodiments, air entering the flow chamber absorbs heat from the flue gas through the shared wall, and is driven out along a sixth gas flow path G₆ to the heat output 106 by incoming air. In turn, the flue gas is driven out of the flue gas chamber along a seventh gas flow path G₇ toward a flue gas output 108 (e.g., exhaust system) by incoming flue gas.

In some embodiments, the combustion component 112 replaces the burner previously used in the heating appliance to increase the heat output from the combustion, while consuming the same type of fuel (e.g., by increasing a pressure of the fuel and oxidant before combustion). In some embodiments, the combustion component utilizes the burner native to the heating appliance. In such embodiments, the combustion component can adjust the operation of the native burner (e.g., via the controller 122) to increase the heat output from the combustion, e.g., by (1) altering a ratio of the fuel to the oxygen in the oxidant, and/or (2) increasing the amount of fuel consumed in the combustion. In some embodiments, the combustion temperature in the combustion component 112 is between about 1200-2500° C., 1600-2400° C., or about 1800-2200° C. The increase in combustion temperature can enable the power cell 130, discussed in more detail below, to more efficiently generate an electrical output. Further, the increase in combustion temperature can help ensure that the power generation system 110 outputs enough unused heat to the CHP system 100 to meet heating demands.

The power cell 130 includes a first heat exchanger 132 (e.g., a hot-side heat exchanger) that is thermally coupled to the combustion component 112, a second heat exchanger 136 (e.g., a cold-side heat exchanger), and an electricity generation component 134 thermally coupled between and to the first and second heat exchangers 132, 136, via respective first and second heat paths H₁, H₂. As such, as heat is transferred from the flue gas into the first heat exchanger 132, the power cell 130 can use the received heat to generate an electrical output.

The electricity generation component 134 has a first portion 135a thermally coupled to the first heat exchanger 132 to receive the heat along the first heat path H₁, and a second portion 135b coupled to the second heat exchanger 136 along a second heat path H₂. As the first heat exchanger 132 receives heat from the combustion process via the flue gas, the first heat exchanger 132 rises in temperature, which in turn causes the first portion 135a of the electricity generation component 134 to rise in temperature as well This creates a temperature difference or gradient between the first portion 135a and the second portion 135b, which can be used to generate an electrical output as heat flows from the first portion to the second portion. As illustrated in FIG. 1, the electricity generation component 134 then directs the electrical output along a power line P₂ into the power electronics 120 for further routing within and/or external to the CHP system 100.

In various embodiments, the electricity generation component 134 can include thermionic energy converters, thermoelectric energy converters, thermoacoustic energy converters, gas turbines, thermophotovoltaics, and/or alkali metal thermal-to-electricity converters. In such embodiments, the electricity generation component 134 generates electricity without any moving physical components, thereby requiring little or no maintenance, even when operating continuously or nearly continuously.

The electrical output from the power cell 130 can be between about 0.01-50 kilowatts (kW) and about 50 kW, 0.05-5 kW, 0.1-1 kW, or about 0.5 kW. In a specific, non-limiting example, the electrical output from the electricity generation component 134 can be between about 0.09-0.4 kW to ensure that the CHP system 100 can fully power any active components in a furnace (e.g., air blowers, temperature sensors, control boards, igniters, and the like) as well as all of the related electrical components (e.g., a thermostat, gas pumps, and the like). In various embodiments, the power electronics 120 can use the electrical output from the electricity generation component 134 to at least partially power (1) one or more devices related to the fuel supply 102 and/or the oxidant supply 114 (e.g., pumps, meters, and/or the like); (2) various components of the heating appliance (e.g., igniters, various other control boards, pumps, fans, vents, valves, and/or the like); and/or (3) various components of the CHP system 100 (e.g., the controller 122, mixers for the combustion component 112, and the like) during a blackout. Additionally or alternatively, the power electronics 120 can use the electrical output from the power cell 130 to offset power consumption on a local power grid (e.g., within a residential home) and/or to export power into a broader power grid during normal operating conditions.

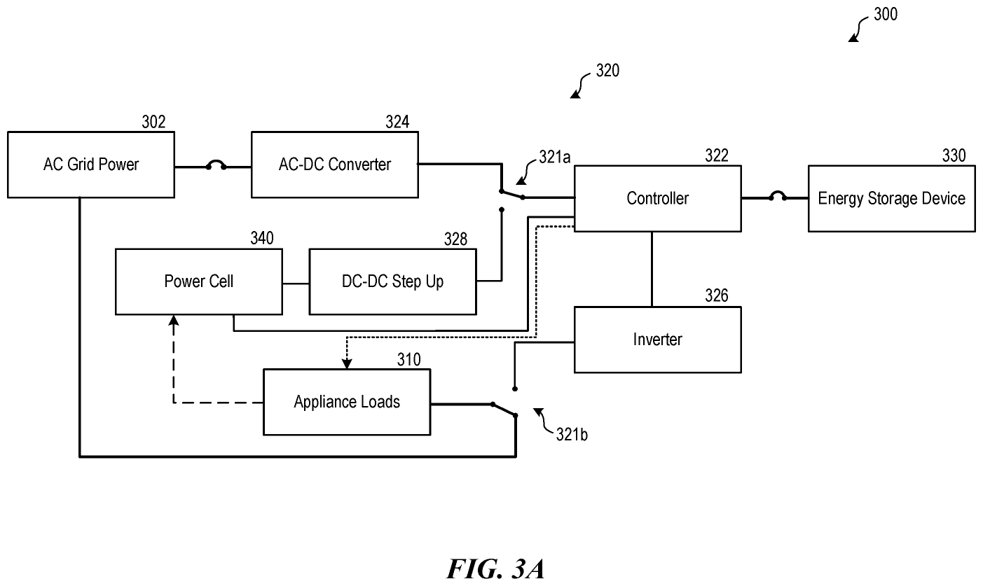

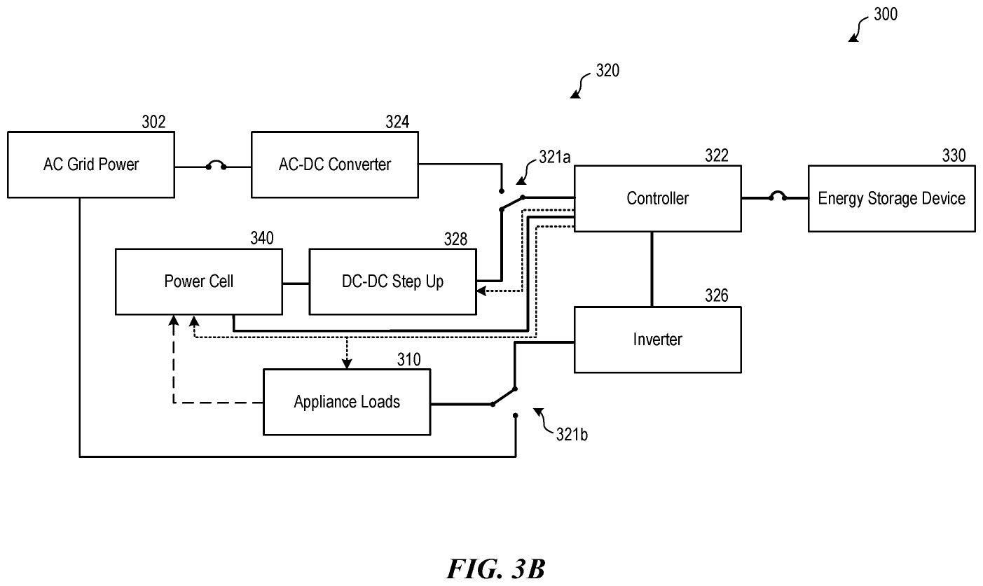

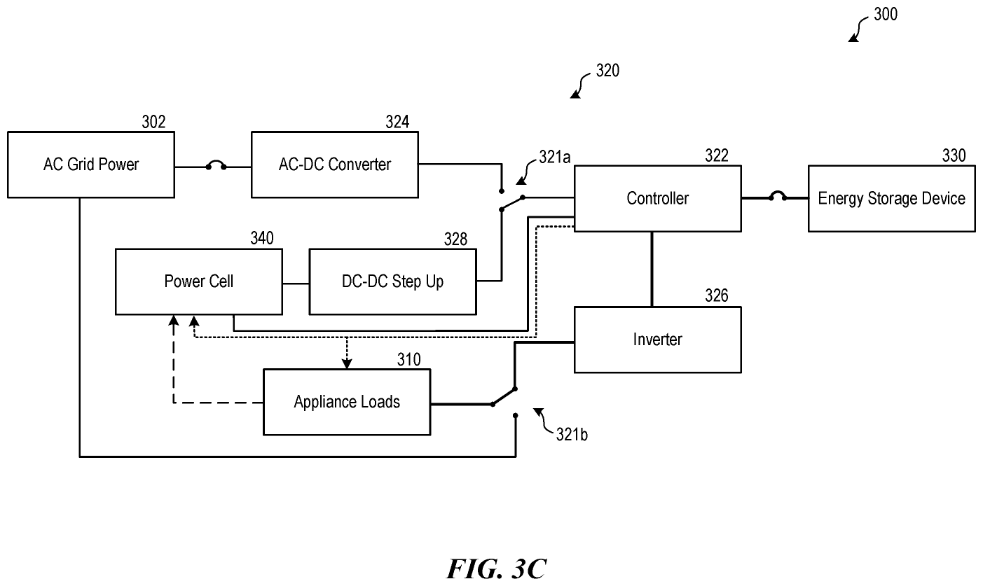

In a particular example, the electrical output can be sufficient to power the active components of the heating appliance, active components of the power generation system 110, and any related devices, thereby allowing the CHP system 100 to be self-sufficient. In such embodiments, the power electronics 120 can use the electrical output from electricity generation component 134 to operate the CHP system 100 even when external electrical power is unavailable and/or insufficient (e.g., during a blackout). Additional details on the power electronics 120, and the control exerted by the controller 122, are described below with reference to FIGS. 3A-7.

As further illustrated in FIG. 1, the unused heat from the electricity generation component 134 (sometimes also referred herein to as “waste heat” and/or “excess heat”) flows out of the electricity generation component 134 and into the second heat exchanger 136 along the second heat path H₂. In turn, the second heat exchanger 136 can be thermally coupled to the third heat exchanger 116 of the heating appliance via a third heat flow path H₃. As a result, heat that the power cell 130 does not convert into electricity can be used for residential heating purposes, such as boiling water, heating water, heating air within a furnace, and/or the like. As discussed above, the heat transferred into the third heat exchanger 116 is then used by the heating appliance and directed into the heat output 106.

It will be understood by one of skill in the art that, in some embodiments, one or more of the heat exchangers described above can be combined into a single heat exchanger. By way of example only, the second and third heat exchanges 136, 116 described above can be combined in a single heat exchanger that transfers heat from the cold side of the energy converter directly to a fluid used in the heating appliance (e.g., air (in the case of a furnace) and/or water (in the case of a boiler)).

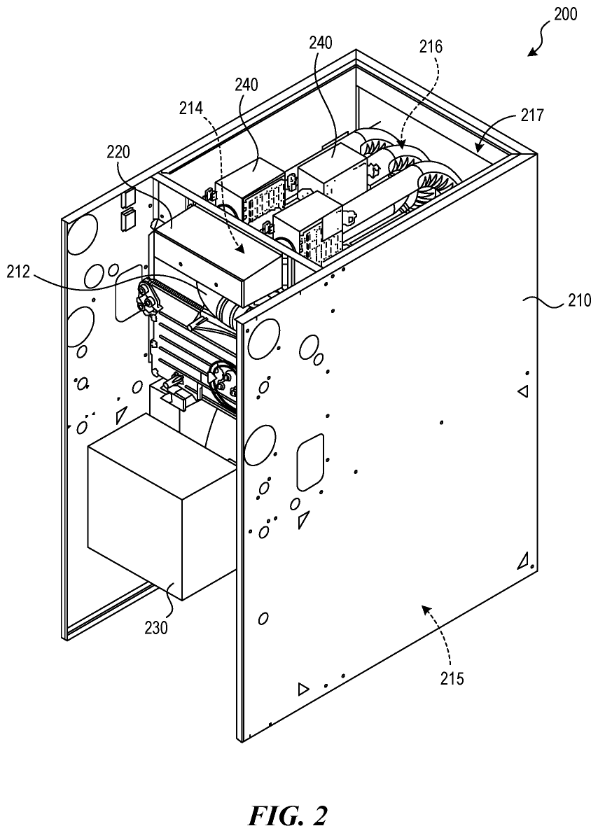

FIG. 2 is a partially schematic isometric view of a CHP system 200 in accordance with embodiments of the present technology. The CHP system 200 can be generally similar to and/or include components of the CHP system 100 described in FIG. 1. As shown in FIG. 2, the CHP system 200 is integrated into a furnace 210, allowing the CHP system 200 to replace a variety of commercially available furnaces. The CHP system 200 also includes power electronics 220 (e.g., the power electronics 120; FIG. 1), a supplemental energy storage device 230, and one or more power cells 240 (three power cells are shown) each operably coupled to the furnace 210.

The furnace 210 includes an intake 212 that is fluidly couplable to a fuel supply and an oxidant supply, a combustion component 214 (e.g., the combustion component 112; FIG. 1) fluidly coupled to the intake 212, and a flue gas chamber 216 fluidly coupled to the combustion component 214. The furnace 210 also includes a flow chamber 217 surrounding the flue gas chamber 216 and an air blower 215 (not visibly shown) fluidly coupled to the flue gas chamber 216. During operation of the furnace 210, the intake 212 receives a fuel gas (e.g., natural gas, methane, and the like) and an oxidant (e.g., air) and communicates the fuel gas and oxidant (“combustants”) to the combustion component 214. The combustion component 214 can mix the combustants and combust the mixture (e.g., via ignition in a burner), which generates a hot flue gas that is directed into the flue gas chamber 216. The flue gas chamber 216 can be defined by conductive coils within the flow chamber 217. As a result, heat from the flue gas can be communicated through the conductive walls and into air in the flow chamber 217. The air blower drives air through the flow chamber 217 and into an outlet (e.g., air duct system) to deliver heated air to a residence, multiple residences (e.g., in an apartment building), a commercial space, and the like.

As illustrated in FIG. 2, the power electronics 220 and the supplemental energy storage device 230 can be spaced apart from the flue gas chamber 216 and/or the flow chamber 217, which can help insulate the power electronics 220 and the supplemental energy storage device 230 from the heat generated by the combustion. In some embodiments, however, the power cells 240 can be thermally coupled to the flue gas chamber 216 adjacent to the combustion component 214. In such embodiments, the power cells 240 can absorb heat from the flue gas, generate an electrical output, and communicate waste heat into the flow chamber 217.

The power electronics 220 can couple one or more of the components of the furnace 210 to power sources during operation. For example, when external power (e.g., power from an electric grid) is available, the power electronics 220 can couple the active components of the furnace 210 (e.g., the combustion component 214, the air blower 215, and the like) to the external power. Additionally, the power electronics 220 can couple the supplemental energy storage device 230 to the external power while the power is available to charge. In another example, as discussed in more detail below, when the external power becomes unavailable and/or drops below an acceptable input level (e.g., during a blackout) for the furnace 210, the power electronics can couple the active components of the furnace 210 to the supplemental energy storage device 230 and/or the power cells 240. As a result, the furnace 210 can continue to operate during the blackout, thereby allowing the CHP system 200 to provide heat during the blackout.

FIGS. 3A-3C are schematic block diagrams of a CHP system 300 illustrating various power distribution schemes, in accordance with=embodiments of the present technology. More specifically, FIG. 3A illustrates the flow of power through power electronics 320 in the CHP system 300 during normal operating conditions (e.g., when external power is available), FIG. 3B illustrates the flow of power through the power electronics 320 during a blackout operation mode, and FIG. 3C illustrates the flow of power through the power electronics 320 during a warm-up blackout operation mode. In each of FIGS. 3A-3C, the active flow of power is illustrated by bolded lines, the flow of control signals is shown by short-dashed lines, and the flow of heat is shown by long-dashed lines. Additionally, the components shown and described in FIGS. 3A-3C can correspond to the corresponding components shown and described in FIGS. 1 and 2. For example, the power electronics and controller of FIGS. 3A-3C can correspond to the respective power electronics 120 and controller 122 of FIG. 1, and vice versa.

As illustrated in FIG. 3A, the system 300 can include power electronics 320, a controller 322, an alternating current (AC)-DC converter 324, an inverter 326, a DC-DC step-up converter 328, an energy storage device 330, and a power cell 340. The power electronics 320 include a first switch 321a and a second switch 321b, and are coupled between a source of AC grid power 302, appliance loads 310, the energy storage device 330, and the power cell 340. In the illustrated operating mode, the first switch 321a electrically couples the controller 322 to the AC grid power 302 through an AC-DC converter 324, while the second switch 321b electrically couples the appliance loads 310 (e.g., a burner, an inducer (or other air blower) configured to supply air (or another suitable oxidant) to the burner, an air mover (or other fluid pump) to carry heat away from the heating appliance (e.g., for home heating purposes), a thermostat, a controller implementing a schedule for the heating appliance and/or a change in set point from the thermostat, and the like) to the AC grid power 302. In this configuration, the AC grid power 302 provides power to the controller 322 to exercise control over the appliance loads 310 and/or the second switch 321b. In turn, the AC grid power 302 provides power to the appliance loads 310, allowing the CHP system 300 to provide heat to the power cells 340 under normal operation of the appliance. Additionally, the controller 322 is electrically coupled to and can monitor the charge status of the energy storage device 330. When the energy storage device 330 is not fully charged, the controller 322 can direct power to the energy storage device 330 to store energy for when a blackout occurs.

In some embodiments, the power cell 340 can be inactive while the external power (e.g., the AC grid power 302) is available. For example, the power cell 340 may not be loaded while the external power is available. In another example, the power cell 340 can be toggled into an inactive state. In a specific, non-limiting example, the power cell 340 can be a thermionic converter, an example of which is described in U.S. patent application Ser. No. 16/841,327 filed Apr. 6, 2020, the disclosure of which is incorporated herein by reference in its entirety. In the inactive state, a Cesium reservoir component of the power cell 340 can withhold and/or withdraw Cesium vapor from a vacuum gap between the hot-side heat exchanger and the cold-side heat exchanger, thereby reducing (or preventing) the generation of electrical discharge therebetween. Additionally or alternatively, the power cell 340 can be thermally decoupled from the heating appliance in the inactive state.

In some embodiments, the power cell 340 is and/or remains thermally coupled to the heating appliance in the inactive state. For example, the power cell 340 can remain thermally coupled to a combustion component in the appliance loads 310 in the inactive state. In such embodiments, the hot-side heat exchanger (e.g., the first heat exchanger 132 of FIG. 1) of the power cell 340 can be warmed-up while the external power is available and ready to provide electrical power if a blackout occurs, as illustrated in FIG. 3B.

Referring to FIG. 3B, when the AC grid power 302 becomes unavailable (or drops below a predetermined threshold level), the first and second switches 321a, 321b can be toggled to alternate the flow of power through the CHP system 300 according to a blackout operation mode or configuration. More specifically, the first switch 321a is actioned to disconnect the power electronics 320 from the AC grid power 302 and connect the power electronics 320 to the power cell 340. Similarly, the second switch 321b is actioned to disconnect the appliance loads 310 from the AC grid power 302 and connect to the power electronics 320. In some embodiments, the first switch 321a and/or the second switch 321b are double throw switches with their mechanical coils coupled to the AC grid power 302. In such embodiments, when the AC grid power 302 drops below a predetermined voltage (e.g., the minimum voltage rating for the heating appliance and/or any other suitable threshold), the first and second switches 321a, 321b can automatically action into the illustrated configuration. Similarly, in some embodiments, the first and second switches 321a, 321b are a part of an AC-coil double poll, double throw (DPDT) mechanical relay such that both the first and second switches 321a, 321b are automatically actioned. In some embodiments, the first switch 321a and/or the second switch 321b are at least partially controlled by the controller 322. The controller 322 can prevent, for example, the first and second switches 321a, 321b from actioning repeatedly when the AC grid power 302 is fluctuating around the predetermined voltage (e.g., maintaining the CHP system 300 in the blackout operation mode until stable power is available).

As illustrated in FIG. 3B, when the first and second switches 321a, 321b are actioned to the blackout operation configuration, the electrical power produced by the power cell 340 can be used to power the controller 322, the appliance loads 310, and/or the energy storage device 330. For example, the electrical output from the power cell 340 can be directed to the DC-DC step-up converter 328 to adjust the voltage of the electrical output (e.g., increasing voltage while decreasing current), then be directed to the inverter 326 (e.g., converting from DC to AC) and toward the appliance loads 310, e.g., to maintain the operation of the heating appliance.

As further illustrated in FIG. 3B, the controller 322 can also implement various controls over the DC-DC step-up converter 328, the appliance loads 310, and/or the power cell 340 in the blackout operation mode. For example, the controller 322 can implement a maximum power point tracking (MPPT) algorithm in the DC-DC step-up converter 328 to continuously adjust the impedance seen by the power cell 340 and maintain optimal (or near optimal) operation of the power cell 340 as conditions vary (e.g., as temperatures in the first and second heat exchangers fluctuate, demand for output heat changes, and the like). Stated differently, the controller 322 can implement the MPPT algorithm in the DC-DC step-up converter 328 to continuously adjust the load on the power cell 340 and realize maximum power output and/or maximum efficiency in the conversion of heat to the electrical output.

In another example, the controller 322 can control various functions of the power cell 340 to adjust operation therein. In a specific, non-limiting example, when the power cell 340 is a thermionic converter, the controller 322 can implement a plasma ignition function (e.g., striking plasma in the vacuum gap to begin producing electric power), operate a Cesium heater (e.g., a resistive heater) coupled to a Cesium reservoir to regulate a vapor pressure of the Cesium in the vacuum gap, add and/or remove Cesium from the vacuum gap, and the like. Said another way, the controller 322 can implement various functions at the power cell 340 that kickstart electrical power generation and/or affect the electrical power generation once started.

In yet another example, the controller 322 can measure the temperature of various components of the power cell 340 (e.g., the hot side heat exchanger and/or the cold side heat exchanger) and implement controls of the appliance loads in response to the measured temperatures. In a specific example, should either of the heat exchangers overheat, the controller 322 can increase a fan speed of one or more air blowers (e.g., the air blower 215 of FIG. 2) to carry additional heat away from the power cell 340. Additionally or alternatively, the controller 322 can alter a combustion rate to increase the amount of heat output from the combustion component. For example, the controller 322 can increase the combustion rate by between about 5-30 percent, 10-25 percent, or by about 20 percent. The additional combustion can help deliver additional heat to the power cell 340 to allow the electrical output power to be generated without diminishing the heat delivered to the appliance. Additionally or alternatively, the controller 322 can alter a ratio of the fuel to oxidant to alter a temperature of the combustion. For example, during normal operating conditions (e.g., when the AC power grid is available), the combustion component can operate with between about 30-50 percent more air than required for a stoichiometric ratio. During blackout-mode operation, the combustion component can operate with between about 10-20 percent more air than required for a stoichiometric ratio. The decrease in the concentration of the air can increase the concentration of the fuel in the combustion, thereby delivering more heat in the output.

In various embodiments of the thermionic converter, the power cell 340 produces the largest amount of power when the hot side heat exchanger is maintained at a temperature between about 800-1400° C. or about 1000-1300° C., and the cold side heat exchanger is maintained at a temperature between about 200-800° C. or 300-600° C.

Each of the controls discussed can improve the overall efficiency of the CHP system 300, increase the electrical output from the power cell 340, and/or maintain the heat output from the heating appliance while the power cell 340 is operating. As a result, the controls can enable the power cell 340 to partially (or fully) provide the power required to operate the heating appliance, thereby blackout-proofing the combined heat and power system.

In some embodiments, the electrical output from the power cell 340 is insufficient to fully operate the heating appliance (e.g., when the temperature gradient between the hot cell and the cold shell is insufficient, when the power required by the appliance loads 310 is relatively high (e.g., heat from the appliance is in high demand), and the like). In such embodiments, the controller 322 can supplement the electrical output from the power cell 340 with power from the energy storage device 330. In such embodiments, the power electronics 320 can include a second DC-DC step-up (e.g., integrated with the controller 322 and/or a separate component) that matches the output from the energy storage device 330 to the output from the power cell 340 to allow the outputs to be sent in parallel to the appliance loads 310.

In some embodiments, the electrical output power from the power cell 340 is greater than the power required to fully operate the heating appliance (e.g., when the power cell 340 is operating efficiently, the load demand is relatively low, and the like). In such embodiments, the controller 322 can direct excess power from the power cell 340 into the energy storage device 330. The excess power generation can allow the power cell 340 to recharge the energy storage device 330 after periods of high demand and/or after a warm-up blackout operation mode, as discussed elsewhere herein. As a result, the excess power generation can allow the CHP system 300 to operate indefinitely during a blackout. Additionally or alternatively, the controller 322 can direct the excess electrical power to an auxiliary outlet on the CHP system 300. As a result, for example, various personal electronic devices can be charged by the excess electrical power production.

Additionally or alternatively, when the electrical output power from the power cell 340 is greater than the power required to fully operate the heating appliance, the controller 322 can implement controls to reduce the electrical output power to the level required by the appliance loads. For example, the controller 322 can alter the algorithm in the DC-DC step-up converter 328 to regulate the output voltage to a fixed voltage below the maximum. In another example, the controller 322 can alter the consumption rate of the fuel and/or the fuel to oxidant ratio to reduce the heat input into the power cell 340.

FIG. 3C illustrates the flow of power through the CHP system 300 when a blackout is detected (e.g., a full blackout or drop below the predetermined voltage) and the power cell 340 is not ready or unable to operate. In these circumstances, the controller 322 can implement a warm-up blackout operation mode to operate the heating appliance (e.g., power the appliance loads 310) until the power cell 340 is ready to operate. As illustrated in FIG. 3C, in the warm-up blackout operation mode, the controller 322 draws electrical power out of the energy storage device 330 and directs the electrical power through the inverter 326 and into the appliance loads 310. The electrical power allows the appliance loads 310 (e.g., the air blower, combustion component, various pumps, and the like) to operate the heating appliance. As discussed above, the heating appliance generates heat during operation, which can then be directed at least partially into the power cell 340 to warm the power cell 340 up.

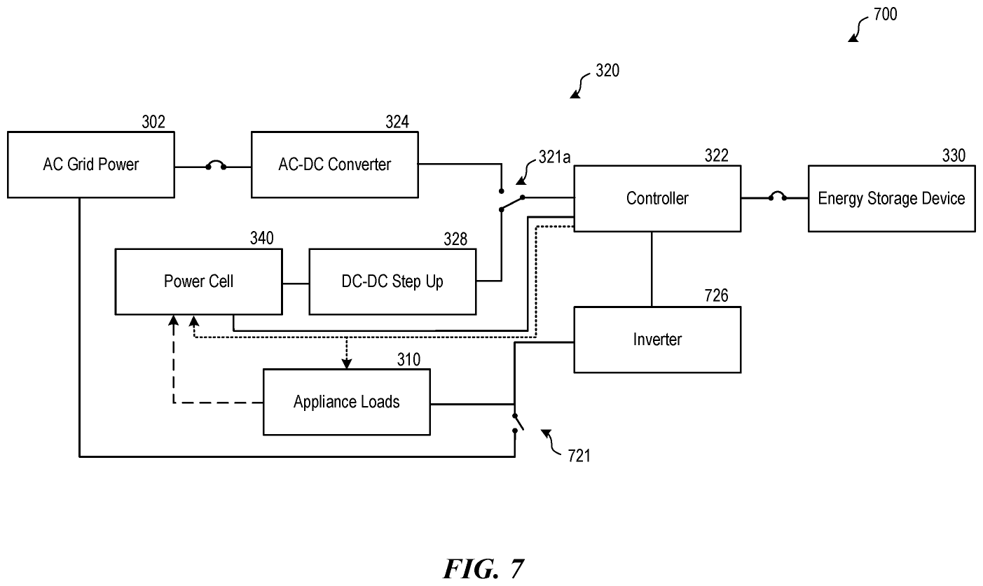

It should be understood by those normally skilled in the art that in some embodiments the heating appliances may have one or more appliance loads that are powered by a DC input. For example, some newer furnaces have variable speed blower motors that run more efficiently on DC power. In such cases, a portion of the power output from the power cell 340 can be provided to the DC-powered appliance loads (e.g., omitting the inverter). However, in such cases, some of the power output from the power cell 340 can still be directed through the inverter to provide power to any remaining appliance loads that require an AC input and/or to provide power back to the grid (as discussed in more detail with respect to FIG. 7).

Further, during the warm-up blackout operation mode, the controller 322 can communicate with the power cell 340 (and/or one or more sensors attached thereto) to monitor the status of the power cell 340 and/or prepare the power cell 340 for operation. For example, the controller 322 can monitor the temperature of the hot side heat exchanger and/or the cold side heat exchanger to determine when a sufficient temperature gradient exists to load the power cell 340 and/or to monitor the temperatures. In a specific, non-limiting example, if the temperature of the cold side heat exchanger rises above a desired level during the warm-up blackout operation, the controller 322 can increase the speed of an air blower in the appliance loads 310 to help reduce the temperature. In another example, the controller 322 can control various aspects of the power cell 340 to prepare for operation. When the power cell 340 includes a thermionic converter that include Cesium vapor in a vacuum gap, the controller 322 can vary the presence and temperature of Cesium vapor in the vacuum gap, e.g., to more quickly prepare the thermionic converter.

The warm-up blackout operation mode can be useful, for example, when a blackout occurs while the heating appliance is not operating and therefore not heating the power cell 340. Purely by way of example, some heating appliances are turned off (or significantly reduced) during the day to conserve energy. In this example, the power cell 340 may not be ready to operate if a blackout occurs. Accordingly, the warm-up blackout operation mode allows the CHP system 300 to provide protection against losses of external power without requiring adjustments to the operating schedule of the heating appliance and/or without requiring the heating appliance to continuously operate to heat the power cell 340.

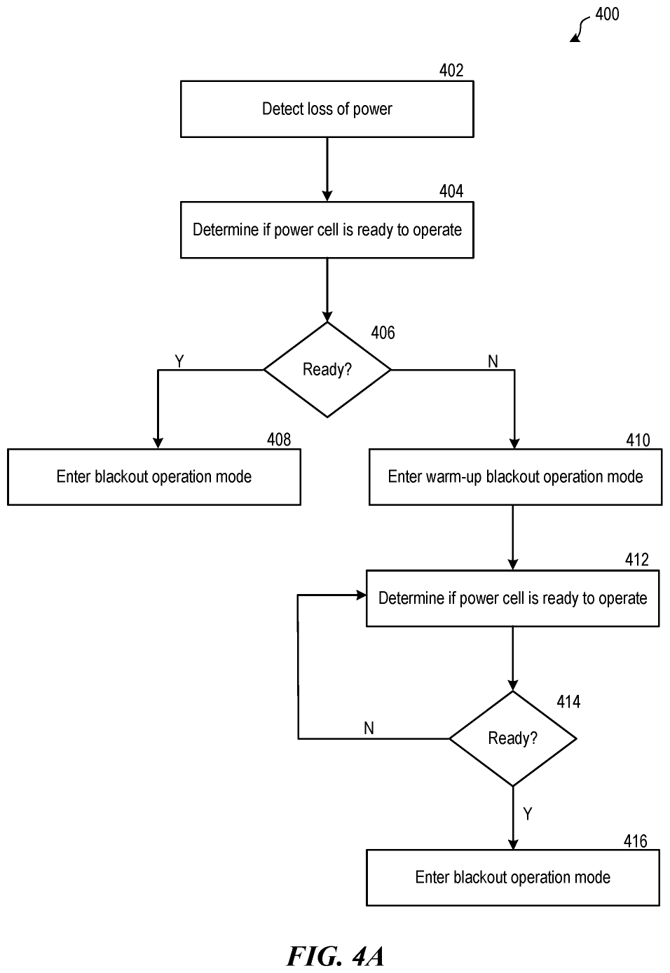

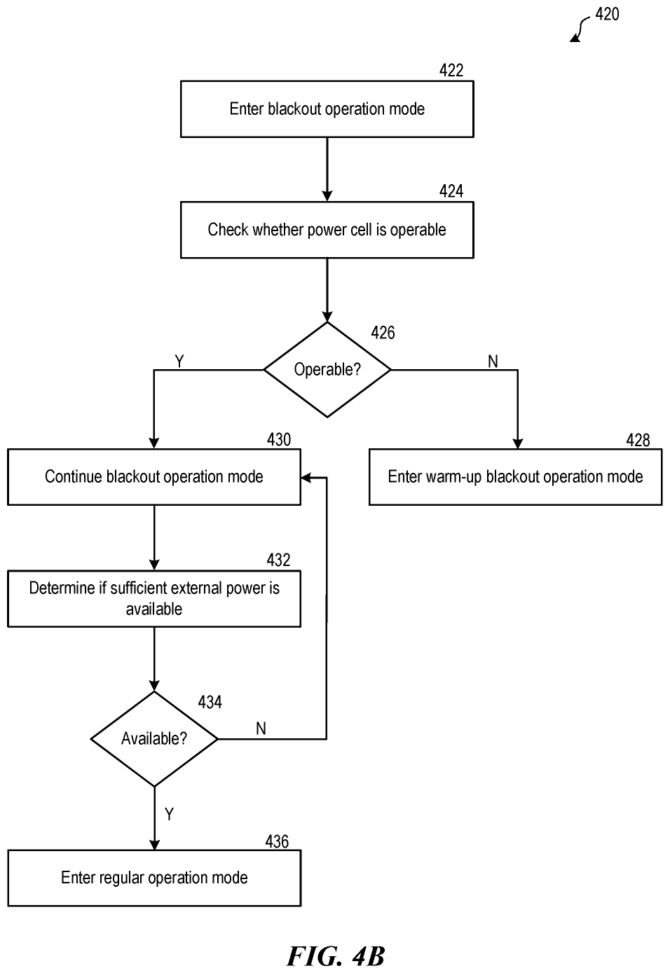

FIGS. 4A and 4B are flow diagrams of processes 400, 420 for operating a CHP system (e.g., the CHP systems 100, 200, 300) in accordance with embodiments of the present technology. Referring first to FIG. 4A, the process 400 can be implemented by any of the controllers discussed above to help provide protection to a CHP system against a loss of power. Moreover, the components discussed with respect to the process 400 can correspond to the corresponding components described elsewhere herein. For example, the power cell described with reference to the process 400 can correspond to the power cell 340 of FIGS. 3A-3C.

The process 400 begins at block 402 by detecting a loss of power. In some embodiments, the loss of power is detected by one or more sensors (e.g., a voltage meter) coupled to the electric grid. A blackout condition can be identified when the voltage available from the grid falls below an input voltage necessary for one or more components of the CHP system and/or is lost altogether. Purely by way of example, a CHP system with a furnace can have a minimum rated input voltage of between about 80 volts and about 100 volts. When the grid power dips below the minimum input voltage (e.g., during a blackout or brownout), the loss can be declared a blackout for the CHP system. In some embodiments, the blackout condition is identified when the voltage available from the grid falls below a predetermined voltage to avoid any risk of damage to components of the CHP system (e.g., at 110 percent, 120 percent, or any other suitable percent of the minimum rated input voltage for a heating appliance).

At block 404, the process 400 determines if the power cell in the CHP system is ready to operate. As discussed above, the determination can be based at least partially on the temperature of the hot and cold heat exchangers in the power cell and/or the gradient therebetween. For example, as discussed above for a thermionic converter, the power cell can require the hot side heat exchanger to be between about 800-1400° C. and/or can require the cold side heat exchanger to be between about 200° C.-800° C. to be ready to operate. Additionally or alternatively, the determination can be based at least partially on the action-status of various components of the power cell. In a specific, non-limiting example of a thermionic converter, the readiness of the power cell can depend on the status (e.g., presence, temperature, pressure, and the like) of Cesium vapor in the vacuum gap of the thermionic converter.

At decision block 406, if the power cell is ready to operate, the process 400 continues to block 408 to enter a blackout operation mode, e.g., as described with reference to FIG. 3B. If the power cell is not ready to operate, the process 400 continues to block 410 to enter a warm-up blackout operation mode, e.g., as described with reference to FIG. 3C.

To enter the blackout operation mode, the process 400 can include coupling the appliance loads to the electrical output from the power cell. As discussed elsewhere herein, the electrical output can be coupled to the appliance loads through a DC-DC step-up converter to ensure the electrical output has a sufficient voltage and/or an inverter to convert the electrical output from DC to AC upstream of the appliance loads. Additionally, when the electrical output contains an insufficient amount of power, the process 400 can include coupling the appliance loads to an energy storage device in parallel with the power cell. In some embodiments, the adjustments to the coupling of the components in the CHP system are accomplished automatically (or semi-automatically) through one or more double throw switches that are coupled to the grid power. In such embodiments, when the grid power (e.g., grid voltage) drops below the predetermined threshold associated with the blackout condition, the double throw switch(es) automatically move(s) from a first position to a second position to adjust the coupling of the components in the CHP system.

In addition to adjusting the coupling of the components in the CHP system, at block 408, the process 400 can include adjustments to the operation of various components of the CHP system. For example, the process 400 can adjust the operation of a combustion component to increase the amount of heat output from the combustion component, action the power cell to allow the power cell to produce power, load the power cell, and change a speed of a heating appliance (e.g., changing an air blower speed in a furnace), and the like, to allow the power cell to produce the electrical output without impeding the heat delivered from the heating appliance.

Similarly, to enter the warm-up blackout operation mode, the process 400 can include coupling the appliance loads to an energy storage device (e.g., the energy storage device 330 of FIG. 3C), through any necessary step-up converters and/or inverters. Additionally, the process 400 can include any of the adjustments to the operation of components of the CHP system discussed above.

Purely by way of example, to enter the warm-up blackout operation mode, the process 400 can adjust the operation of the combustion component to increase the amount of heat being output. The increase in heat can help quickly warm the power cell for operation.

At block 412, the process 400 determines if the power cell is ready to operate. As discussed elsewhere herein, the power cell's readiness to operate can depend on the temperature of various components of the power cell and/or the action-status of various components.

At decision block 414, if the power cell is ready to operate, the process 400 continues to block 416 to enter the blackout operation mode. If the power cell is not ready to operate, the process 400 returns to block 412 to provide the power cell with additional time to warm up. In some embodiments, the process 400 implements various checks to determine if the power cell is ready to operate periodically (e.g., every five minutes, ten minutes, half-hour, hour, and/or any other suitable period) to allow the power cell time to warm up. In some embodiments, the process 400 implements a continuous or quasi-continuous check. For example, where the temperature of components of the power cell is the limiting factor, the process 400 can continuously track the temperature to continuously determine whether the power cell is ready to operate.

Referring next to FIG. 4B, the process 420 can be implemented by any of the controllers discussed above to help provide protection to a CHP system against a loss of power. Moreover, the components discussed with respect to the process 420 can correspond to the corresponding components described elsewhere herein. For example, the power cell described with reference to the process 420 can correspond to the power cell 340 of FIGS. 3A-3C. The process 420 begins at block 422 with entering the blackout operation mode. Similar to the discussion above with reference to block 406 (FIG. 4A), to enter the blackout operation mode, the process 420 can include coupling the appliance loads to the electrical output from the power cell. Additionally, when the electrical output contains an insufficient amount of power, the process 420 can include coupling the appliance loads to an energy storage device in parallel with the power cell.

At block 424, the process 420 checks whether the power cell is still operable. Purely by way of example, at block 424, the process 420 can check the temperature of one or more components of the power cell. When one or more of the components departs from an ideal temperature range (e.g., between about 800-1400° C. for the hot side heat exchanger and/or between about 200° C.-800° C. for the cold side heat exchanger).

At decision block 426, if the power cell is not operable, the process 420 continues to block 428 to enter a warm-up blackout operation mode, as described with reference to block 410 of FIG. 4A. Alternatively, if the power cell is still operable, the process 420 continues to block 430 and continues to operate in the blackout operation mode.

In some embodiments, the process 420 implements checks periodically (e.g., every five minutes, ten minutes, half-hour, hour, and/or any other suitable period) to determine if the power cell is still operable. In some embodiments, the process 420 implements a continuous, or quasi-continuous, check. For example, where the temperature of components of the power cell is the limiting factor, the process 420 can continuously track the temperature to continuously check whether the power cell is still operable.

At block 432, the process 420 determines whether sufficient external power is available to operate the CHP system. The determination at block 432 can be based on the voltage of external power that is available, the stability of the external power, and/or how long the external power has been available. Purely by way of example, the determination at block 432 can check whether the external power exceeds a predetermined threshold (e.g., the minimum input voltage for a heating appliance, a threshold greater than the minimum input voltage for a heating appliance, about 80 volts (in AC), and/or any other suitable threshold). If the external power does not exceed the predetermined threshold, the process 420 can determine that external power is not available. In another example, the determination at block 432 can check the stability of the external power (e.g., based on measured fluctuations in the external power). If the stability is insufficient (e.g., too large of a standard deviation, recent deviations beneath the minimum input power, and the like), the process 420 can determine that external power is not available. In yet another example, the determination at block 432 can check how long the voltage of the external power has been above the minimum input and/or predetermined threshold for the heating appliance. If the voltage of the external power has not been above the minimum input for the heating appliance for more than a predetermined amount of time (e.g., five minutes, half an hour, one hour, or any other suitable length of time), the process 420 can determine that external power is not available. In each of the examples above, the process 420 can avoid switching out of the blackout operation mode prematurely (e.g., before sufficient power is consistently available). By avoiding switching out of the blackout operation mode prematurely, the process 420 can reduce a risk of damage to components of the CHP system due to insufficient power, reduce the risk of interruptions to the heat and/or power available from the CHP system (e.g., the heating appliance shutting off due to an insufficient input), extend the lifetime of the CHP system (e.g., by reducing the overall number of switches), and the like.

At decision block 434, if sufficient external power is available, the process 420 continues to block 436 to enter regular operation mode. For example, the process 420 can include coupling the appliance loads to the external power, coupling the energy storage device to the external power, and/or unloading the power cell. As a result, the CHP system can return to the configuration illustrated in FIG. 3A. Alternatively, if sufficient external power is not available at decision block 434, the process 420 returns to block 430 to continue in the blackout operation mode. In some embodiments, the process 420 implements the checks at blocks 432-434 to check if the external power is available periodically (e.g., every five minutes, ten minutes, half-hour, hour, and/or any other suitable period). In some embodiments, the process 420 implements a continuous, or quasi-continuous, check to switch back to normal operation as soon as the external power is sufficiently available.

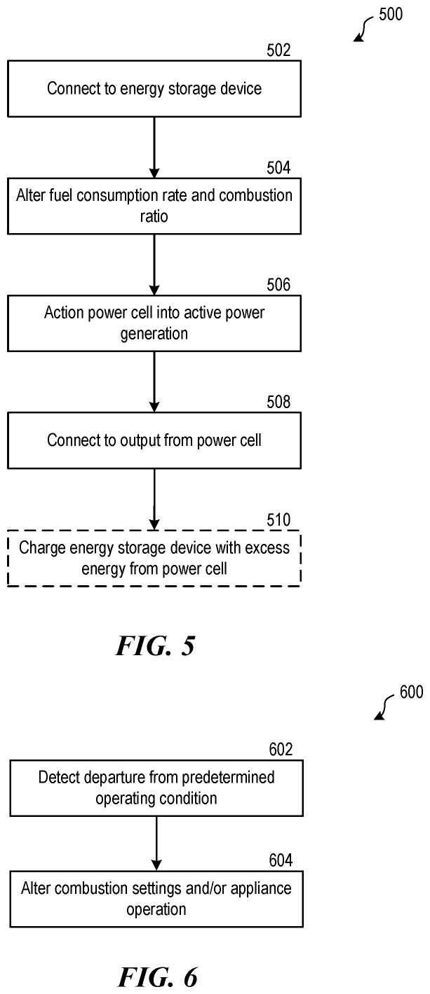

FIG. 5 is a flow diagram of a process 500 for warming up a CHP system during a blackout in accordance with embodiments of the present technology. The process 500 can be implemented by any of the controllers discussed above to warm up the CHP system from a cold start during a loss of power. For example, the process 500 can be initiated after block 410 of FIG. 4 and be implemented alongside blocks 412-416 to transition from the warm-up blackout operation mode and transition into a power cell-driven blackout operation mode.

The process 500 begins at block 502 by connecting the active components of the CHP system (e.g., the appliance loads 310 of FIG. 3C) to an energy storage device (e.g., the energy storage device 330 of FIG. 3C). As discussed above, the energy storage device can be coupled to the active components through a suitable step-up converter and/or an inverter, as necessary, to deliver power to the active components. As a result, the energy storage device allows the CHP system to start from cold (e.g., no recent activity) during a blackout condition.

At block 504, the process 500 includes altering the fuel consumption rate of the CHP system and/or the combustion ratio (fuel:oxidant) in the combustion component. For example, as discussed above, the process 500 can increase the consumption rate of the fuel by between about 5-30 percent, between about 10-25 percent, or by about 20 percent. The additional combustion can help deliver additional heat to quickly prepare the power cell for operation. Additionally or alternatively, the process 500 can alter a fuel:oxidant ratio from between about 30-50 percent more air than required for a stoichiometric ratio to between about 10-20 percent more air than required for a stoichiometric ratio. As discussed elsewhere herein, the adjustment can increase the heat in the output from the combustion component, thereby helping to quickly heat the power cell for operation.

At block 506, the process 500 includes actioning any relevant components of the power cell to begin generating an electrical output. For example, at block 506 the process 500 can include loading the power cell, coupling the power cell to an output line, providing an input to various components of the power cell, and the like. In a specific, non-limiting example, at block 506 the process 500 can include providing a heated, pressurized Cesium vapor to a vacuum gap of a thermionic converter. Once actioned, the power cell can begin producing an electrical output, allowing the CHP system to enter the blackout operation mode (e.g., as opposed to the warm-up blackout operation mode) and reduce the system's consumption of power from the energy storage device. Once the power cell begins generating the electrical output, at block 508, the process 500 includes connecting the active components of the CHP system to the power cell.

In some embodiments, when the electrical output from the power cell is insufficient to power the active components, the process 500 can couple the power cell to the active components in parallel with the energy storage device. As a result, the energy storage device can supplement the power cell and account for any variances in the output while conserving some energy. When the electrical output from the power cell is sufficient to power the active components, the process 500 includes disconnecting the active components from the energy storage device. In such embodiments, the disconnection allows any remaining power in the energy storage device to be conserved for future cold starts and/or to supplement the electrical output if the power cell drops below the required level.

At optional block 510, when the electrical output from the power cell exceeds the level required to power the active components, the process 500 can include coupling the energy storage device to the power cell. In such embodiments, the excess power can recharge the energy storage device. As a result, the CHP system can be reset and capable of multiple cold starts when the AC grid power is unavailable for an extended period. Additionally, or alternatively, the recharging can allow the energy storage device to supplement dips in the output from the power cell. Additionally, or alternatively, when the electrical output from the power cell exceeds the level required to power the active components, the process 500 can make the excess energy available to a local output. For example, the process 500 can use the excess power to charge various personal electronic devices that are plugged into the CHP system, provide power to the home, and/or export power back to the grid.

FIG. 6 is a flow diagram of a process 600 for adjusting operation of a CHP system to maintain optimal power generation in accordance with embodiments of the present technology. The process 600 can be implemented by any of the controllers discussed above to help maintain efficient operation of the CHP system.

The process 600 begins at block 602 with detecting a departure from a predetermined operating condition in one or more of the components in the CHP system. For example, the departure can include a variance in the temperature of the hot side heat exchanger in the power cell outside of a predetermined range, a variance in the temperature of the cold side heat exchanger in the power cell outside of a predetermined range, a variance in the heat gradient in the power cell outside of a predetermined range, a variance in the temperature of the air leaving the furnace outside of a desired temperature range, a variance in the temperature of the flue gas leaving the combustion component outside of a desired temperature range, and the like. In a specific, non-limiting example, where the power cell includes thermionic energy converters, the departure can include a variance in the temperature of the Cesium reservoir which determines the partial pressure of the Cesium vapor in the gap of the converter outside of a predetermined range.

At block 604, the process 600 includes altering the combustion settings within the CHP system and/or the appliance operation settings to counteract the detected departure. For example, when the temperature of the hot side heat exchanger in the power cell departs from (e.g., below or above) a desired temperature range, the process 600 can adjust (e.g., increase or decrease) the fuel consumption rate to help drive the temperature back toward the desired temperature range. Additionally or alternatively, the process 600 can adjust the operation of the appliance (e.g., decreasing or increasing the speed of an air blower that absorbs heat from the heat cell) to help drive the temperature back toward the desired temperature range.

FIG. 7 is a schematic block diagram of a combined heat and power system illustrating a power distribution scheme, in accordance with embodiments of the present technology. As illustrated, the CHP system 700 of FIG. 7 is generally similar to the CHP system 300 of FIGS. 3A-3C. For example, the CHP system 700 of FIG. 7 includes power electronics 320 that are coupled between an AC grid power 302 source, appliance loads 310, an energy storage device 330, and a power cell 340. The power electronics 320 include a controller 322, an AC-DC converter 324 coupling the controller 322 to the AC grid power 302, and a DC-DC step-up converter 328 between the power cell 340 and the controller 322. As discussed above, this arrangement allows the controller 322 to direct power and/or control signals between various components of the CHP system 700 according to the operation mode and/or the status of the AC grid power 302.

In the illustrated embodiment, the power electronics 320 also include a grid-tie inverter 726 that is operably coupled to the controller 322 to send power from the CHP system 300 (e.g., from the power cell 340) into the AC grid power 302 through a switch 721. The grid-tie inverter 726 converts the DC output from the power cell 340 to an AC output, and synchronizes the frequency and output voltage to the frequency and voltage of the AC grid power 302. As a result, when the AC grid power 302 is available, the controller 322 can operate the power cell 340 to generate an electrical output, action the switch 721 (e.g., a single pole, single throw switch) to couple the power cell 340 to the external grid 302, and then direct the electrical output into the AC grid power 302. This can allow the power cell 340 to stay warm during the operation of the CHP system 700, reduce switching time when the AC grid power 302 is lost, and/or offset costs from the CHP system 700 (e.g., by selling power back to the AC grid power). In some embodiments, the power directed through the grid-tie inverter 726 is used locally (e.g., by other appliances in a residential unit, apartment building, office building and the like), thereby reducing the energy costs of the local appliances. In some embodiments, the power directed through the grid-tie inverter 726 is directed to another endpoint coupled to the AC grid power 302 in exchange for a credit and/or another form of compensation.

### EXAMPLES

The present technology is illustrated, for example, according to various aspects described below as numbered examples (1, 2, 3, etc.). These examples do not limit the present technology. It is noted that any of the dependent examples can be combined in any suitable manner, and placed into a respective independent example. The other examples can be presented in a similar manner.

1. A combined heat and power system, comprising:

a heating appliance comprising:
one or more active components operably coupleable to an external grid and configured to receive a voltage input to operate the heating appliance;
at least one burner configured to receive a mixture comprising a fuel and an oxidant and generate a flue gas having heat; and
an exhaust channel fluidly coupled to the at least one burner and configured to transport the flue gas away from the heating appliance; and

power electronics operatively coupled to the heating appliance, the power electronics comprising a controller configured to detect a voltage output available from the external grid,

wherein, in operation, when the voltage output available from the external grid drops below a predetermined threshold, the controller enters a blackout operation mode.

2. The combined heat and power system of any one of the examples herein, further comprising an energy storage device operably coupled to the controller, wherein entering the blackout operation mode comprises electrically coupling the energy storage device to the one or more active components and/or the at least one burner of the home appliance.

3. The combined heat and power system of example 2, further comprising an inverter configured to convert DC input voltage to AC output voltage, wherein the inverter is operably coupled to the controller and the energy storage device, and wherein, in the blackout operation mode, the energy storage device provides a DC input voltage to the inverter and the inverter provides AC output voltage to the one or more active components and/or the at least one burner.

4. The combined heat and power system of example 2 wherein entering the blackout operation mode comprises electrically isolating the one or more active components of the home appliance from the external grid.

5. The combined heat and power system of any one of the examples herein, further comprising a power cell thermally coupled to the exhaust channel and configured to receive a portion of the heat from the flue gas, wherein the power cell is operable to generate a voltage output

6. The combined heat and power system of example 5, further comprising an energy storage device operably coupled to the controller, wherein, in the blackout operation mode, the energy storage device produces a first voltage output and the power cell simultaneously produces a second voltage output.

7. The combined heat and power system of any one of the examples herein wherein, when the voltage output drops below the predetermined threshold, the controller transitions from a normal operation mode to the blackout operation mode, wherein, in the normal mode, the controller is configured to:

determine a charge status of the energy storage device; and

when the energy storage device is not fully charged, charge the energy storage device via the external grid.

8. The combined heat and power system of any one of the examples herein wherein, when the voltage output drops below the predetermined threshold, the controller transitions from a normal operation mode to the blackout operation mode, wherein (i) in the normal mode, the at least one burner receives the mixture at a first flow rate, and (ii) in the blackout operation mode, the at least one burner receives the mixture at a second flow rate higher than the first flow rate.

9. The combined heat and power system of any one of the examples herein wherein entering the blackout operation mode comprises increasing a flow rate of the mixture to the at least one burner to increase heat output therefrom.

10. The combined heat and power system of any one of the examples herein wherein entering the blackout operation mode comprises increasing a flow rate of the fuel provided to the at least one burner and decreasing a flow rate of the oxidant provided to the at least one burner.

11. The combined heat and power system of any one of the examples herein, further comprising a power cell thermally coupled to the exhaust channel and configured to receive a portion of the heat from the flue gas, wherein the power cell is a thermionic converter including a hot side temperature and a cold side temperature, and wherein entering the blackout operation mode comprises adjusting a flow rate of the fuel based on the hot side temperature and adjusting a flow rate of the oxidant based on the cold side temperature.

12. The combined heat and power system of example 11 wherein the controller is configured to control the one or more active components and/or the at least one burner such that the hot side temperature is in a range of 800-1400° C. and the cold side temperature is in a range of 200-800° C.

13. The combined heat and power system of any one of the examples herein, wherein the power cell is a thermionic converter (TEC) including a plasma ignition circuit and a TEC gap configured to receive an alkali metal fluid, and wherein, in the blackout operation mode, the plasma ignition circuit is configured to strike a plasma in the TEC gap to produce power.

14. The combined heat and power system of any one of the examples herein wherein the power electronics further comprise a grid-tie inverter, and wherein the controller is configured to direct an electrical output from the power cell to the external grid through the grid-tie inverter.

15. A combined heat and power system, comprising:

a burner configured to combust a fuel and an oxidant and generate a flue gas;

a blower configured to supply the oxidant to the burner;

an energy storage device operably couplable to an external grid;

a controller operably coupled to the burner, and the energy storage device, wherein the controller is configured to determine a power output available from the external grid; and

one or more switches each moveable between a first position and a second position,

wherein—
when the power output is equal to or above a predetermined threshold, the one or more switches are configured to be in the first position such that the blower is electrically coupled to the external grid, and
when the power output is below the predetermined threshold, the one or more switches are configured to be in the second position such that the blower is coupled to the energy storage device.

16. The combined heat and power system of any one of the examples herein wherein:

when the one or more switches are in the first position, the blower is electrically isolated from the energy storage device, and

when the one or more switches are in the second position, the blower is electrically isolated from the external grid.

17. The combined heat and power system of any one of the examples herein, further comprising a relay operably coupled to the one or more switches, wherein:

when the voltage output is equal to or above the predetermined threshold, the relay is in an energized state such that the one or more switches are controlled to be in the first position, and

when the voltage output is below the predetermined threshold, the relay is in a deenergized state such that the one of more switches are controlled to be in the second position.

18. The combined heat and power system of any one of the examples herein, further comprising an inverter operably coupled to the controller and the energy storage device and configured to convert DC input voltage to AC input voltage, wherein, when the voltage output is below the predetermined threshold, the energy storage device provides a DC input voltage to the inverter and the inverter provides an AC input voltage to the blower.

19. The combined heat and power system of any one of the examples herein, further comprising a power cell thermally coupled to the blower via the flue gas, wherein, when the power output is below the predetermined threshold, the energy storage device produces a first power output and the power cell simultaneously produces a second power output.

20. The combined heat and power system of any one of the examples herein, wherein, when the power output is below the predetermined threshold, the controller is configured to:

determine a charge status of the energy storage device; and

when the energy storage device is not fully charged, charge the energy storage device via a power output from the power cell.

21. A method for operating a combined heat and power system, the method comprising:

operating a burner and an air blower, wherein operating the air blower is based on a first voltage output received from an external grid, and wherein operating the burner comprises combusting fuel and air and generating a flue gas;

determining that the first voltage output from the external grid is below a predetermined threshold;

after determining that the first voltage output is below the predetermined threshold:
electrically coupling the air blower to an energy storage device such that the air blower operates based on a second power output provided from the energy storage device; and
electrically coupling the energy storage device to a power cell, wherein the power cell is thermally coupled to the flue gas and is configured to produce a third power output.

22. The method of example 21 wherein operating the air blower based on the first power output comprises operating in a normal mode, the method further comprising, in the normal mode, charging the energy storage device via the first power output external grid.

23. The method of example 21 wherein operating the air blower based on the first power output comprises providing to the burner a mixture of the fuel and the air at a first flow rate, the method further comprising, after determining that the first power output is below the predetermined threshold, providing to the burner the mixture at a second flow rate higher than the first flow rate.

24. The method of example 21 wherein operating the air blower based on the first power output comprises operating the burner at a first air-to-fuel ratio, the method further comprising, after determining that the first power output is below the predetermined threshold, operating the air blower at a second air-to-fuel ratio lower than the first air-to-fuel ratio.

25. The method of example 21 wherein the power cell is a thermionic converter including a hot side temperature and a cold side temperature, the method further comprising, after determining that the first power output is below the predetermined threshold, adjusting (i) a flow rate of the fuel provided to the burner, by an inducer, based on the hot side temperature and (ii) a flow rate of the air provided to the burner, by the inducer, based on the cold side temperature.

26. The method of example 21 wherein the power cell is a thermionic converter including a hot side temperature and a cold side temperature, the method further comprising, after determining that the first power output is below the predetermined threshold:

adjusting a flow rate of the fuel provided to the burner such that the hot side temperature is in a range of 800-1400° C.; and

adjusting a flow rate of the air provided to the burner such that the cold side temperature is in a range of 200-800° C.

27. A combined heat and power system, comprising:

a heating appliance comprising:
one or more active components operably coupleable to an external grid to receive an electrical input to operate the heating appliance;
at least one burner configured to receive and combust a fuel and an oxidant and generate a flue gas;
an exhaust channel fluidly coupled to the at least one burner and configured to transport the flue gas away from the heating appliance; and
a flow channel thermally coupled to the exhaust channel, wherein the flow channel is configured to receive a first portion of heat from the flue gas;

a power cell thermally coupled to the exhaust channel and configured to receive a second portion of the heat from the flue gas, wherein the power cell is operable to generate an electrical output from the second portion of the heat; and

power electronics operatively coupled to the heating appliance and the power cell, the power electronics comprising a controller configured to:
detect electrical power available from the external grid; and
determine whether the power cell is ready to operate,

wherein, in operation:
when the electrical power is below a predetermined threshold and the power cell is ready to operate, the controller enters a blackout operation mode, and
when the electrical power is below a predetermined threshold and the power cell is not ready to operate, the controller enter a warm-up blackout operation mode.

28. The combined heat and power system of example 27 wherein, in the blackout operation mode, the controller is configured to:

adjust a fuel consumption rate of the at least one burner to increase heat output therefrom;

action the power cell to an active power generation mode; and

electrically couple the power cell to the one or more active components of the heating appliance.

29. The combined heat and power system of example 27 wherein the power cell is a thermionic converter, and wherein toggling the power cell into the active power generation mode includes providing a Cesium vapor to the thermionic converter.

30. The combined heat and power system of example 27 wherein the power electronics further include a direct current (DC) to DC step-up component and an inverter, and wherein the power cell is electrically coupled to the one or more active components through the DC to DC step-up component and the inverter.

31. The combined heat and power system of example 27, further comprising an energy storage device operably coupled to the controller, wherein, in the warm-up blackout operation mode:

the controller is configured to adjust a fuel consumption rate of the at least one burner; and

the energy storage device is operably coupled to the one or more active components of the heating appliance to provide the electrical input.

32. The combined heat and power system of example 31 herein, to enter the warm-up blackout operation mode, the controller is further configured to adjust a combustion ratio between the fuel and the oxidant to increase a temperature of the combustion.

33. The combined heat and power system of example 27 wherein the power electronics further comprise a grid-tie inverter, and wherein, when no reduction in the external is detected, the controller is further configured to direct the electrical output from the power cell into an external grid through the grid-tie inverter.

34. The combined heat and power system of example 27, further comprising an energy storage device, and wherein, when no reduction in the external electrical power is detected, the controller is further configured to:

determine a charge status of the energy storage device; and

when the energy storage device is not fully charged, coupled the energy storage device to the external grid to charge.

35. The combined heat and power system of example 27, further comprising an energy storage device, and wherein, when in the blackout operation mode, the controller is further configured to:

determine a charge status of the energy storage device; and

when the energy storage device is not fully charged, electrically couple the power cell to the energy storage device to provide at least a second portion of the electrical output to charge the energy storage device.

36. The combined heat and power system of example 27 wherein the one or more active components of the heating appliance include at least one of:

an air blower fluidly coupled to the flow channel to drive air through the flow channel and into an airduct;

an igniter operatively coupled to the at least one burner; and

a pump operatively coupleable between at least one of the one or more inputs and the at least one burner to deliver the fuel to the at least one burner.

37. A combined heat and power system, comprising:

at least one burner fluidly couplable a fuel supply and an oxidant supply to receive a fuel and oxidant for combustion within the at least one burner, wherein the combustion generates heat carried by a flue gas;

a power cell thermally coupled to the at least one burner to receive a first portion of the heat from the flue gas;

an energy storage device operably couplable to an external grid;

a heat exchanger thermally coupled between the at least one burner and a flow channel of a heating appliance to transfer a second portion of the heat from the flue gas into the flow channel; and

a controller operably coupled to the at least one burner, the power cell, and the energy storage device, wherein the controller includes instructions that when executed cause the controller to:
detect a reduction in electrical power from the external grid below a predetermined threshold; and
determine whether the power cell is ready to operate, wherein:
   when the power cell is ready to operate, the instructions further cause the controller to switch the combined heat and power system into a blackout operation mode, and
   when the power cell is not ready to operate, the instructions further cause the controller to switch the combined heat and power system into a warm-up blackout operation mode.

38. The combined heat and power system of example 37 wherein, in the blackout operation mode, the power cell is operatively coupled to one or more active components of the heating appliance to provide an electrical input power required to operate the heating appliance.

39. The combined heat and power system of example 38 wherein, in the blackout operation mode, the power cell is operatively coupled to the one or more active components of the heating appliance to supplement the electrical input power provided by the power cell.

40. The combined heat and power system of example 37 wherein, in the warm-up blackout operation mode, the power cell is operatively coupled to one or more active components of the heating appliance to provide an electrical input power required to operate the heating appliance.

41. The combined heat and power system of example 37 wherein the power cell comprises:

a first heat exchanger thermally coupled to the at least one burner to receive the first portion of the heat;

a second heat exchanger opposite the first heat exchanger; and

an electricity generation component having a first portion thermally coupled to the first heat exchanger and a second portion thermally coupled to the second heat exchanger, wherein the electricity generation component is positioned to generate an electrical output using the first portion of the heat.

42. The combined heat and power system of example 41, further comprising a temperature sensor thermally coupled to the first heat exchanger, wherein, when the combined heat and power system is in the warm-up blackout operation mode, the instructions further cause the controller to:

alter a fuel consumption rate of the at least one burner and/or a ratio of the fuel to the oxidant in the combustion to increase an output of the heat from the combustion;

measure a temperature of the first heat exchanger using the temperature sensor;

determine, based at least partially on the temperature of the first heat exchanger, when the power cell is ready to operate; and

when the power cell is ready to operate, switch the combined heat and power system into the blackout operation mode.

43. The combined heat and power system of example 41 further comprising a temperature sensor thermally coupled to the first heat exchanger, wherein, when the combined heat and power system is in the blackout operation mode, the instructions further cause the controller to:

measure a temperature of the first heat exchanger using the temperature sensor; and

when the temperature exceeds a predetermined threshold, alter a fuel consumption rate of the at least one burner and/or a ratio of the fuel to the oxidant in the combustion to reduce the output of the heat from the combustion.

44. The combined heat and power system of example 41 wherein:

the second heat exchanger is in thermal communication with the flow channel of the heating appliance to communicate waste heat into the flow channel;

the combined heat and power system further comprises a temperature sensor thermally coupled to the second heat exchanger; and

when the combined heat and power system is in the blackout operation mode, the instructions further cause the controller to:
measure a temperature of the second heat exchanger using the temperature sensor; and
when the temperature exceeds a predetermined threshold, increase a flow through the flow channel to increase a transfer rate of the waste heat into the flow channel.

45. A method for operating a combined heat and power system, the method comprising:

detecting a reduction in an electrical power from an external grid below a predetermined threshold; and

determining whether a power cell integrated with the combined heat and power system is ready to operate, wherein:
when the power cell is ready to operate, entering a blackout operation mode, wherein entering the blackout operation mode includes:
   coupling active components of the combined heat and power system to the power cell to receive an electrical output from the power cell; and
when the power cell is not ready to operate, entering a warm-up blackout operation mode, wherein entering the warm-up blackout operation mode includes:
   coupling the active components of the combined heat and power system to an energy storage device integrated with the combined heat and power system; and
   increasing a fuel consumption rate of a combustion component in the combined heat and power system to increase a heat output of the combustion component.

46. The method of example 45, wherein entering the blackout operation mode further includes increasing the fuel consumption rate of the combustion component to increase the heat output of the combustion component.

47. The method of example 45, wherein entering the warm-up blackout operation mode further includes altering a ratio of fuel to oxidant combusted by the combustion component to increase the heat output of the combustion component.

48. The method of example 45, wherein, when the combined heat and power system is in the blackout operation mode, the method further comprises:

detecting a departure from a predetermined operating temperature range in a hot side heat exchanger of the power cell; and

altering the fuel consumption rate of the combustion component to adjust the heat output of the combustion component based on the detected departure.

49. The method of example 45, wherein, when the combined heat and power system is in the blackout operation mode, the method further comprises:

detecting a departure from a predetermined operating temperature range in a cold side heat exchanger of the power cell; and

altering a flow rate of through a heating appliance in the combined heat and power system to adjust an amount of heat removed from the cold side heat exchanger based on the detected departure.

50. A combined heat and power system, comprising:

appliance loads comprising a burner configured to combust a fuel and an oxidant and generate a flue gas, and a blower configured to supply the oxidant to the burner;

an energy storage device operably couplable to an external grid;

a controller operably coupled to the burner, and the energy storage device, wherein the controller is configured to determine a power output available from the external grid; and

one or more switches each moveable between a first position and a second position,

wherein—
when the power output is equal to or above a predetermined threshold, the one or more switches are configured to be in the first position such that one or more of the appliance loads are electrically coupled to the external grid, and
when the power output is below the predetermined threshold, the one or more switches are configured to be in the second position such that one or more of the appliance loads are coupled to the energy storage device.

51. The combined heat and power system of example 50, further comprising a power cell thermally coupled to the burner via the flue gas.

52. The combined heat and power system of example 51 wherein, when the power output is below the predetermined threshold, the second position of the one or more switches electrically couples the one or more of the appliance loads to the power cell.

53. The combined heat and power system of example 51 wherein, when the power output is below the predetermined threshold, the energy storage device produces a first power output and the power cell simultaneously produces a second power output.

54. The combined heat and power system of example 51, wherein:

when the one or more switches are in the first position, the one or more appliance loads are electrically isolated from the energy storage device, and

when the one or more switches are in the second position, the one or more appliance loads are electrically isolated from the external grid.

55. The combined heat and power system of example 51, further comprising a relay operably coupled to the one or more switches, wherein:

when the power output is equal to or above the predetermined threshold, the relay is in an energized state such that the one or more switches are controlled to be in the first position, and

when the power output is below the predetermined threshold, the relay is in a deenergized state such that the one of more switches are controlled to be in the second position.

56. The combined heat and power system of example 51, further comprising an inverter operably coupled to the controller and the energy storage device and configured to convert DC power to AC power, wherein, when the power output is below the predetermined threshold, the energy storage device provides DC power to the inverter and the inverter provides AC power to the one or more of the appliance loads.

57. A method for operating a combined heat and power system, the method comprising:

operating a burner and an air blower, wherein operating the air blower is based on a first power output received from an external grid, and wherein operating the burner comprises combusting fuel and air and generating a flue gas;

determining that the first power output from the external grid is below a predetermined threshold; and

after determining that the first power output is below the predetermined threshold electrically coupling the air blower to an energy storage device such that the air blower operates based on a second power output provided from the energy storage device.

58. The method of example 57 wherein operating the air blower based on the first power output comprises operating in a normal mode, the method further comprising, in the normal mode, charging the energy storage device via the first power output external grid.

59. The method of example 57 wherein operating the air blower based on the first power output comprises providing to the burner the air at a first flow rate to be mixed with the fuel, and wherein operating the air blower based on the second power output comprises providing to the burner the air at a second flow rate higher than the first flow rate.

60. The method of example 57 wherein operating the air blower based on the first power output comprises providing the air to the burner at a first excess air ratio, and wherein operating air blower based on the second power output comprises providing the air to the burner at a second excess air ratio lower than the first excess air ratio.

61. The method of example 57 wherein the power cell is a thermionic converter including a hot side temperature and a cold side temperature, the method further comprising, after determining that the first power output is below the predetermined threshold, adjusting (i) a flow rate of the fuel provided to the burner based on the hot side temperature and (ii) a flow rate of the air based on the cold side temperature.

62. The method of example 57 wherein the power cell is a thermionic converter including a hot side temperature and a cold side temperature, the method further comprising, after determining that the first power output is below the predetermined threshold:

adjusting a flow rate of the fuel provided to the burner such that the hot side temperature is in a range of 800-1400° C.; and

adjusting a flow rate of the air provided to the burner such that the cold side temperature is in a range of 200-800° C.

### Conclusion

It will be apparent to those having skill in the art that changes may be made to the details of the above-described embodiments without departing from the underlying principles of the present disclosure. In some cases, well known structures and functions have not been shown or described in detail to avoid unnecessarily obscuring the description of the embodiments of the present technology. Although steps of methods may be presented herein in a particular order, other embodiments may perform the steps in a different order. For example, injecting the primary fluid can occur before, after, or concurrent with injecting the oxidant gas. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Throughout this disclosure, the singular terms “a,” “an,” and “the” include plural referents unless the context clearly indicates otherwise. The term “and/or” when used in reference to a list of two or more item is to be interpreted as including (a) any single item in the list, (b) all of the items in the list, or (c) any combination of the items in the list. Additionally, the term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing numerical values (e.g., pressures, temperatures, etc.) used in the specification and claims, are to be understood as being modified in all instances by the term “about” or “approximately.” The terms “about” or “approximately,” when used in reference to a value, are to be interpreted to mean within 10% of the stated value. Accordingly, unless indicated to the contrary, the numerical parameters set forth in the following specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10, e.g., 5.5 to 10.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

We claim:

1. A combined heat and power system, comprising:
a heating appliance comprising:
one or more active components operably coupleable to an external grid and configured to receive an input power to operate the heating appliance;
at least one burner configured to receive a mixture comprising a fuel and an oxidant and generate a flue gas having heat; and
an exhaust channel fluidly coupled to the at least one burner and configured to transport the flue gas away from the heating appliance;
a power cell thermally coupled to the exhaust channel and configured to receive a portion of the heat from the flue gas, wherein the power cell is operable to generate a power output; and
power electronics operatively coupled to the heating appliance and the power cell, the power electronics comprising a controller configured to detect voltage available from the external grid,
wherein, in operation, when the voltage available from the external grid drops below a predetermined threshold, the controller enters a blackout operation mode.

2. The combined heat and power system of claim 1, further comprising an energy storage device operably coupled to the controller, wherein entering the blackout operation mode comprises electrically coupling the energy storage device to the one or more active components and/or the at least one burner of the home appliance.

3. The combined heat and power system of claim 2, further comprising an inverter configured to convert DC power to AC power, wherein the inverter is operably coupled to the controller and the energy storage device, and wherein, in the blackout operation mode, the energy storage device provides DC power to the inverter and the inverter provides AC power to the one or more active components and/or the at least one burner.

4. The combined heat and power system of claim 2 wherein the power output from the power cell is a second power output, and wherein, in the blackout operation mode, the energy storage device produces a first power output simultaneous to the power cell producing the second power output.

5. The combined heat and power system of claim 2 wherein entering the blackout operation mode comprises electrically isolating the one or more active components of the home appliance from the external grid.

6. The combined heat and power system of claim 1 wherein, when the voltage available from the external grid drops below the predetermined threshold, the controller transitions from a normal operation mode to the blackout operation mode, wherein, in the normal mode, the controller is configured to:
determine a charge status of the energy storage device; and
when the energy storage device is not fully charged, charge the energy storage device via the external grid.

7. The combined heat and power system of claim 1 wherein, when the voltage available from the external grid drops below the predetermined threshold, the controller transitions from a normal operation mode to the blackout operation mode, wherein (i) in the normal mode, the at least one burner receives the mixture at a first flow rate, and (ii) in the blackout operation mode, the at least one burner receives the mixture at a second flow rate higher than the first flow rate.

8. The combined heat and power system of claim 1 wherein entering the blackout operation mode comprises increasing a flow rate of the mixture to the at least one burner to increase heat output therefrom.

9. The combined heat and power system of claim 1 wherein entering the blackout operation mode comprises increasing a flow rate of the fuel provided to the at least one burner and decreasing a flow rate of the oxidant provided to the at least one burner.

10. The combined heat and power system of claim 1 wherein the power cell is a thermionic converter including a hot side temperature and a cold side temperature, and wherein entering the blackout operation mode comprises adjusting a flow rate of the fuel based on the hot side temperature and adjusting a flow rate of the oxidant based on the cold side temperature.

11. The combined heat and power system of claim 10 wherein the controller is configured to control the one or more active components and/or the at least one burner such that the hot side temperature is in a range of 800-1400° C. and the cold side temperature is in a range of 200-800° C.

12. The combined heat and power system of claim 1, wherein the power cell is a thermionic converter (TEC) including a plasma ignition circuit and a TEC gap configured to receive an alkali metal fluid, and wherein, in the blackout operation mode, the plasma ignition circuit is configured to strike a plasma in the TEC gap to produce power.

13. The combined heat and power system of claim 1 wherein the power electronics further comprise a grid-tie inverter, and wherein the controller is configured to direct the power output from the power cell to the external grid through the grid-tie inverter.

14. A combined heat and power system, comprising:
appliance loads comprising a burner configured to combust a fuel and an oxidant and generate a flue gas, and a blower configured to supply the oxidant to the burner;
an energy storage device operably couplable to an external grid;
a controller operably coupled to the burner, the blower, and the energy storage device, wherein the controller is configured to determine a voltage output available from the external grid; and
one or more switches each moveable between a first position and a second position,
wherein—
when the voltage output is equal to or above a predetermined threshold, the one or more switches are configured to be in the first position such that one or more of the appliance loads are coupled to the external grid, and
when the voltage output is below the predetermined threshold, the one or more switches are configured to be in the second position such that one or more of the appliance loads are coupled to the energy storage device.

15. The combined heat and power system of claim 14, wherein:
when the one or more switches are in the first position, the air blower is electrically isolated from the energy storage device, and
when the one or more switches are in the second position, the air blower is electrically isolated from the external grid.

16. The combined heat and power system of claim 14, further comprising a relay operably coupled to the one or more switches, wherein:
when the voltage output is equal to or above the predetermined threshold, the relay is in an energized state such that the one or more switches are controlled to be in the first position, and
when the voltage output is below the predetermined threshold, the relay is in a deenergized state such that the one of more switches are controlled to be in the second position.

17. The combined heat and power system of claim 14, further comprising an inverter operably coupled to the controller and the energy storage device and configured to convert DC power to AC power, wherein, when the voltage output is below the predetermined threshold, the energy storage device provides DC power to the inverter and the inverter provides AC power to the air blower.

18. The combined heat and power system of claim 14, further comprising a power cell thermally coupled to the burner via the flue gas.

19. The combined heat and power system of claim 18 wherein, when the voltage output is below the predetermined threshold, the controller is configured to:
determine a charge status of the energy storage device; and
when the energy storage device is not fully charged, charge the energy storage device via a voltage output from the power cell.

20. A method for operating a combined heat and power system, the method comprising:
operating a burner and an air blower, wherein operating the air blower is based on a voltage output received from an external grid, and wherein operating the burner comprises combusting fuel and air and generating a flue gas;
determining that the voltage output from the external grid is below a predetermined threshold;
after determining that the voltage output is below the predetermined threshold:
electrically coupling the air blower to an energy storage device such that the air blower operates based on a first power output provided from the energy storage device; and
electrically coupling the energy storage device to a power cell, wherein the power cell is thermally coupled to the flue gas and is configured to produce a second power output.

21. The method of claim 20 wherein operating the air blower on the first power output comprises operating in a normal mode, the method further comprising, in the normal mode, charging the energy storage device via the voltage output available from the external grid.

22. The method of claim 20 wherein operating the air blower based on the voltage output comprises providing to the burner the air at a first flow rate to be mixed with the fuel, and wherein operating the air blower based on the second power output comprises providing to the burner the air at a second flow rate higher than the first flow rate.

23. The method of claim 20 wherein operating the air blower based on the voltage output comprises providing the air to the burner at a first air-to-fuel ratio, and wherein operating the air blower based on the second power output comprises operating the air blower at a second air-to-fuel ratio lower than the first air-to-fuel ratio.

24. The method of claim 20 wherein the power cell is a thermionic converter including a hot side temperature and a cold side temperature, the method further comprising, after determining that the voltage output is below the predetermined threshold, adjusting (i) a flow rate of the fuel provided to the burner based on the hot side temperature and (ii) a flow rate of the air based on the cold side temperature.

25. The method of claim 20 wherein the air is a first air, and wherein the power cell is a thermionic converter including a hot side temperature and a cold side temperature, the method further comprising, after determining that the voltage output is below the predetermined threshold:
adjusting a flow rate of the fuel provided to the burner and/or a flow rate of the air provided to the burner such that the hot side temperature is in a range of 800-1400° C.; and
adjusting a flow rate of a second air provided to the thermionic converter such that the cold side temperature is in a range of 200-800° C.
